(19) United States
(12) Patent Application Publication
(10) Pub. No.: US 2024/0207948 A1
(43) Pub. Date: Jun. 27, 2024

(54) CHUCK DEVICE AND POWER TOOL

(71) Applicant: Nanjing Chervon Industry Co., Ltd., Nanjing (CN)

(72) Inventors: Biao Zhang, Nanjing (CN); Hongtao Ke, Nanjing (CN)

(21) Appl. No.: 18/498,607

(22) Filed: Oct. 31, 2023

(30) Foreign Application Priority Data
Dec. 26, 2022 (CN) 202211679332.8

(51) Int. Cl. B23B 31/175

(52) U.S. Cl. CPC B23B 31/16195

(57) ABSTRACT

A chuck device includes a connecting mechanism and a locking mechanism, where the locking mechanism includes a driving portion, a first locking portion and a second locking portion, where the first locking portion at least partially extends into a first receiving portion; and the second locking portion is rotatably connected to the first receiving portion through a second shaft. When the locking mechanism is in a first state, the second locking portion rotates along a first direction to drive a sleeve to bias against a biasing element and release a limitation on the first locking portion.

### RELATED APPLICATION INFORMATION

This application claims the benefit under 35 U.S.C. § 119(a) of Chinese Patent Application No. CN 202211679332.8, filed on Dec. 26, 2022, which application is incorporated herein by reference in its entirety.

### TECHNICAL FIELD

The present application relates to the technical field of power tools and, in particular, to a chuck device and a power tool.

### BACKGROUND

Power tools in the related art are generally mechanical tools that operate by using motors as power to drive working accessories through transmission mechanisms.

A working accessory is mounted and fixed by a chuck device. At present, a common manner in the related art is to unlock and lock a clamped part with an additional accessory such as a key. Another keyless manner is to provide an operating button. When the working accessory is inserted into the chuck device, one hand is required to press a quick clamp button and the other hand is required to insert the working accessory.

This part provides background information related to the present application, which is not necessarily the existing art.

### SUMMARY

A chuck device for clamping a working accessory includes a connecting mechanism formed with a first receiving portion used for receiving the working accessory and extending along a first axis; and a locking mechanism connected to the connecting mechanism and used for retaining the working accessory in the first receiving portion. The locking mechanism includes a driving portion including a sleeve and a biasing element, where the sleeve supports the biasing element; a first locking portion at least partially extending into the first receiving portion; and a second locking portion rotatably connected to the first receiving portion through a second shaft. The locking mechanism includes a first state in which the second locking portion rotates about an axis of the second shaft along a first direction to drive the sleeve to bias against the biasing element, and the second locking portion drives the sleeve to release a limitation on the first locking portion.

In some examples, the second locking portion includes an elongated rocker arm.

In some examples, the locking mechanism includes a second state in which the biasing element provides the second locking portion with a biasing force for rotation about the axis of the second shaft along a second direction so that the first locking portion limits a displacement of the working accessory along a direction of the first axis.

In some examples, the second direction is opposite to the first direction.

In some examples, the locking mechanism includes a third state in which the sleeve is driven to compress the biasing element so that a biasing force of the biasing element is removed from the first locking portion.

In some examples, the first locking portion and the second locking portion move relatively to release retention of the working accessory by the first locking portion.

In some examples, the biasing element transmits a biasing force to the second locking portion through the sleeve.

In some examples, the first locking portion is movably connected to the second locking portion.

In some examples, the first locking portion moves on the second locking portion.

In some examples, a contact point between the first locking portion and the second locking portion and a contact point between the sleeve and the second locking portion are located on two sides of the second shaft.

In some examples, the first locking portion includes a spherical structure.

In some examples, a groove is provided on the outer peripheral surface of the working accessory, and when the working accessory is retained in the first receiving portion, the first locking portion is at least partially located in the groove.

In some examples, the connecting mechanism is provided with a slot communicating with the first receiving portion, and the first locking portion and the second locking portion are disposed in the slot.

In some examples, the second locking portion is disposed on a downstream side of the first locking portion along an insertion direction of the working accessory.

In some examples, when the working accessory is retained in the first receiving portion, the second locking portion and a sidewall of the slot are capable of limiting the first locking portion on two sides of the first locking portion, separately.

In some examples, the sleeve is disposed on the periphery of the connecting mechanism, an inner wall of the sleeve is provided with a first limiting structure, the connecting mechanism is provided with a second limiting structure, and the first limiting structure and the second limiting structure are spaced apart along a direction of the first axis.

In some examples, the first limiting structure is disposed on an upstream side of the second limiting structure along an extraction direction of the working accessory, and the biasing element is disposed between the first limiting structure and the second limiting structure.

In some examples, when the working accessory is retained in the first receiving portion, the first limiting structure is capable of limiting a side of the first locking portion facing away from the working accessory, and when the first limiting structure releases the limitation on the first locking portion, the working accessory is unlocked from the first receiving portion, and the first locking portion is driven to move in a direction away from the working accessory.

A chuck device for clamping a working accessory includes a connecting mechanism formed with a first receiving portion used for receiving the working accessory and extending along a first axis; and a locking mechanism connected to the connecting mechanism and used for retaining the working accessory in the first receiving portion. The locking mechanism includes a driving portion including a sleeve and a biasing element, where the sleeve supports the biasing element; a first locking portion at least partially extending into the first receiving portion; and a second locking portion including an elongated rocker arm and rotatably connected to the first receiving portion through a second shaft; where the first locking portion moves on the second locking portion. The locking mechanism includes a first state in which the second locking portion rotates about an axis of the second shaft along a first direction to drive the sleeve to release a limitation on the first locking portion.

In some examples, a power tool includes a tool body and a chuck device as described herein, where the chuck device is coupled to the tool body and formed on or connected to an output shaft of the tool body.

### BRIEF DESCRIPTION OF THE DRAWINGS

FIG. 1 is a structural view of an impact screwdriver as a power tool according to an example of the present application.

FIG. 2 is a partial structural view one of an impact screwdriver as a power tool according to an example of the present application.

FIG. 3 is a partial structural view two of an impact screwdriver as a power tool according to an example of the present application.

FIG. 4 is a structural view of a chuck device in an initial state according to an example of the present application.

FIG. 5 is a structural view of a chuck device when a working accessory is being inserted according to an example of the present application.

FIG. 6 is a structural view of a chuck device when a working accessory is locked according to an example of the present application.

FIG. 7 is a structural view of a chuck device when a working accessory is unlocked according to an example of the present application.

FIG. 8 is a side view of a chuck device according to an example of the present application.

FIG. 9 is a sectional view of a second locking portion and a second shaft in another form according to an example of the present application.

FIG. 10 is a structural view of a second locking portion and a second shaft in another form according to an example of the present application.

FIG. 11 is a structural view of a polisher as a power tool according to an example of the present application.

### DETAILED DESCRIPTION

Before any examples of this application are explained in detail, it is to be understood that this application is not limited to its application to the structural details and the arrangement of components set forth in the following description or illustrated in the above drawings.

In this application, the terms “comprising”, “including”, “having” or any other variation thereof are intended to cover an inclusive inclusion such that a process, method, article or device comprising a series of elements includes not only those series of elements, but also other elements not expressly listed, or elements inherent in the process, method, article, or device. Without further limitations, an element defined by the phrase “comprising a . . . ” does not preclude the presence of additional identical elements in the process, method, article, or device comprising that element.

In this application, the term “and/or” is a kind of association relationship describing the relationship between associated objects, which means that there can be three kinds of relationships. For example, A and/or B can indicate that A exists alone, A and B exist simultaneously, and B exists alone. In addition, the character “/” in this application generally indicates that the contextual associated objects belong to an “and/or” relationship.

In this application, the terms “connection”, “combination”, “coupling” and “installation” may be direct connection, combination, coupling or installation, and may also be indirect connection, combination, coupling or installation. Among them, for example, direct connection means that two members or assemblies are connected together without intermediaries, and indirect connection means that two members or assemblies are respectively connected with at least one intermediate members and the two members or assemblies are connected by the at least one intermediate members. In addition, “connection” and “coupling” are not limited to physical or mechanical connections or couplings, and may include electrical connections or couplings.

In this application, it is to be understood by those skilled in the art that a relative term (such as “about”, “approximately”, and “substantially”) used in conjunction with quantity or condition includes a stated value and has a meaning dictated by the context. For example, the relative term includes at least a degree of error associated with the measurement of a particular value, a tolerance caused by manufacturing, assembly, and use associated with the particular value, and the like. Such relative term should also be considered as disclosing the range defined by the absolute values of the two endpoints. The relative term may refer to plus or minus of a certain percentage (such as 1%, 5%, 10%, or more) of an indicated value. A value that did not use the relative term should also be disclosed as a particular value with a tolerance. In addition, “substantially” when expressing a relative angular position relationship (for example, substantially parallel, substantially perpendicular), may refer to adding or subtracting a certain degree (such as 1 degree, 5 degrees, 10 degrees or more) to the indicated angle.

In this application, those skilled in the art will understand that a function performed by an assembly may be performed by one assembly, multiple assemblies, one member, or multiple members. Likewise, a function performed by a member may be performed by one member, an assembly, or a combination of members.

In this application, the terms “up”, “down”, “left”, “right”, “front”, and “rear” and other directional words are described based on the orientation or positional relationship shown in the drawings, and should not be understood as limitations to the examples of this application. In addition, in this context, it also needs to be understood that when it is mentioned that an element is connected “above” or “under” another element, it can not only be directly connected “above” or “under” the other element, but can also be indirectly connected “above” or “under” the other element through an intermediate element. It should also be understood that orientation words such as upper side, lower side, left side, right side, front side, and rear side do not only represent perfect orientations, but can also be understood as lateral orientations. For example, lower side may include directly below, bottom left, bottom right, front bottom, and rear bottom.

The present application provides a power tool. In this example, an impact screwdriver 100 is used as an example. In other alternative examples, the power tool may be other power tools, such as a drill, a hedge trimmer, a router, an electric router, a sander and an angular tool. It is to be understood that any power tool having an output shaft and a working accessory attached to the output shaft can adopt the technical solutions disclosed in this example, and any power tools adopting the technical solutions disclosed in this example are within the scope of the present application.

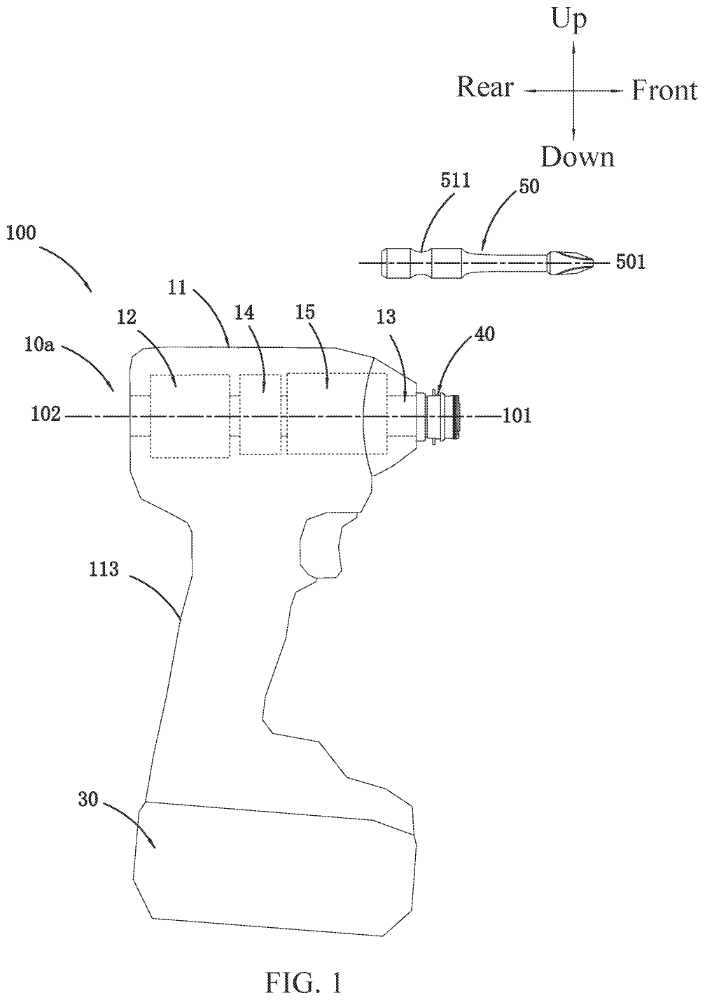

As shown in FIGS. 1 to 3, the impact screwdriver 100 includes a tool body 10a and a chuck device 40 coupled to the tool body 10a. A working accessory 50 is used for implementing the function of the impact screwdriver 100 and detachably connected to the impact screwdriver 100.

In this example, the impact screwdriver 100 further includes a power supply 30. The power supply 30 is used for supplying electrical energy to the impact screwdriver 100. In this example, the power supply 30 is a battery pack, and the battery pack mates with a corresponding power circuit to supply power to corresponding components in the impact screwdriver 100. It is to be understood by those skilled in the art that the power supply 30 is not limited to the battery pack and may supply power to the corresponding components in the impact screwdriver 100 through mains electricity or an alternating current power supply in conjunction with corresponding rectifier, filter and voltage regulator circuits.

The tool body 10a includes a housing 11, an electric motor 12, an output mechanism 13, a transmission mechanism 14 and an impact mechanism 15. The housing 11 includes a motor housing for accommodating the electric motor 12 and an output housing for accommodating at least part of the output mechanism 13. The output housing is connected to a front end of the motor housing. The housing 11 is also formed with or connected to a grip 113 for a user to operate. The grip 113 and the motor housing form a T-shaped or L-shaped structure, which is convenient for the user to hold and operate. The power supply 30 is connected to an end of the grip 113. The power supply 30 is detachably connected to the grip 113.

The electric motor 12 includes a motor shaft rotating about a motor axis 102.

The output mechanism 13 includes an output shaft 131 connected to the working accessory 50 and used for driving the working accessory 50 to rotate. The output shaft 131 is used for outputting power and rotates about an output axis. In this example, the motor axis 102 coincides with the output axis. In other alternative examples, the motor axis 102 is parallel to but does not coincide with the output axis. In other alternative examples, the motor axis 102 intersects the output axis at an angle.

In this example, the chuck device 40 is formed at or connected to an end of the output shaft 131 and may clamp corresponding working accessories 50 to implement different functions, such as a screwdriver, a drill bit and a wrench.

The transmission mechanism 14 is disposed between the electric motor 12 and the impact mechanism 15 and used for transmitting power between the motor shaft and the impact mechanism 15. In this example, the transmission mechanism 14 adopts a gear reduction mechanism. Optionally, the transmission mechanism 14 adopts a planetary gear reduction mechanism. The working principle of planetary gear reduction and the principle of reduction by the transmission mechanism have been fully disclosed to those skilled in the art. Therefore, a detailed description is omitted here for brevity of description.

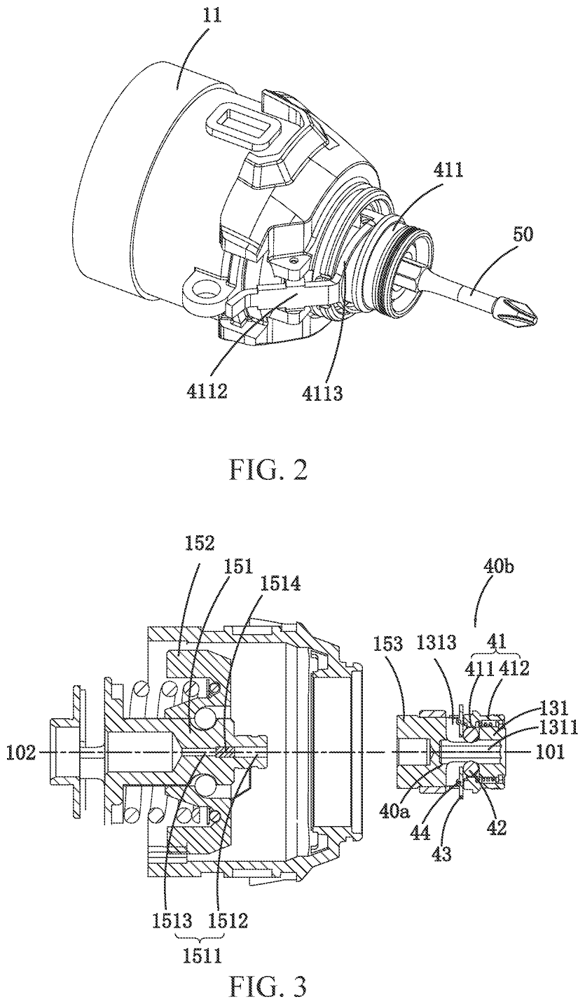

The impact mechanism 15 is used for supplying an impact force to the output shaft 131. Referring to FIG. 3, the impact mechanism 15 includes a main shaft 151, an impact hammer 152 and a hammer anvil 153. The output shaft 131 is formed on or connected to the hammer anvil 153. Optionally, the hammer anvil 153 and the output shaft 131 may be formed integrally or separately formed as independent parts. The output shaft 131 is rotatable about the output axis. The working principle of a mechanical impact mechanism and the principle of impact by the impact mechanism have been fully disclosed to those skilled in the art. Therefore, a detailed description is omitted here for brevity of description.

For the impact screwdriver 100, in the related art, the output shaft 131 is provided with a penetrating exhaust hole. However, the exhaust hole is a weak point of strength of the impact screwdriver that outputs relatively large torque, causing the breakage of the output shaft 131 during working. If the exhaust hole is removed, after lubricating oil is added to the output shaft 131, a certain vapor lock may be generated during the assembly of the main shaft 151 and the output shaft 131, resulting in difficult assembly. For the preceding problem, in the present application, the main shaft 151 is provided with a through hole 1511 penetrating along an axial direction of the main shaft 151, the through hole 1511 is a stepped hole, and the diameter of a front hole 1512 is greater than the diameter of a rear hole 1513. A rubber column 1514 is mounted in the front hole 1512. During the assembly of the main shaft 151 and the output shaft 131, the rubber column 1514 can provide a certain axial movement stroke to provide space for air flow and avoid or reduce the vapor lock during assembly. After the assembly, the rubber column 1514 prevents the formation of a passage through the through hole 1511 so that grease at a rear end of the output shaft 131 and grease in the transmission mechanism 14 cannot communicate. With the preceding arrangement, the problem of weak strength of the output shaft 131 caused by the exhaust hole is solved.

The specific structure of the chuck device 40 is described in detail below.

The chuck device 40 includes a connecting mechanism 40a and a locking mechanism 40b, where the connecting mechanism 40a is formed on or connected to the output shaft 131. In this example, the output shaft 131 is directly used as the connecting mechanism 40a. In other alternative examples, the connecting mechanism 40a may be connected to the output shaft as an independent component.

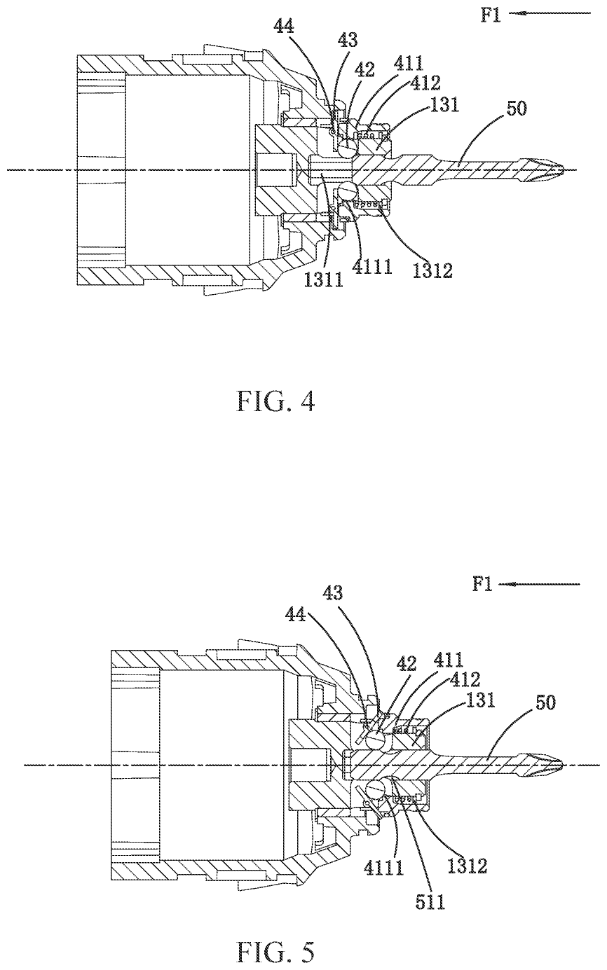

For convenience of description, the tool body 10a of the impact screwdriver 100 is used as an example below. Referring to FIGS. 4 to 8, the connecting mechanism 40a is formed with a first receiving portion 1311 for receiving the working accessory 50, that is, the output shaft 131 is formed with the first receiving portion 1311, and the first receiving portion 1311 extends along a first axis 101. In this example, the first axis 101 coincides with the output axis. In some examples, the first axis 101 is parallel to but does not coincide with the output axis or the first axis 101 and the output axis are arranged at an angle.

The locking mechanism 40b is connected to the connecting mechanism 40a and used for retaining the working accessory 50 in the first receiving portion 1311. The locking mechanism 40b includes a driving portion 41, a first locking portion 42 and a second locking portion 43. The driving portion 41 includes a sleeve 411 and a biasing element 412, where the sleeve 411 is sleeved on the periphery of the output shaft 131, an inner wall of the sleeve 411 is provided with a first limiting structure 4111, the output shaft 131 is provided with a second limiting structure 1312, the first limiting structure 4111 and the second limiting structure 1312 are spaced apart along a direction of the first axis 101, and the first limiting structure 4111 is disposed on an upstream side of the second limiting structure 1312 along an extraction direction F2 of the working accessory 50. The biasing element 412 is sleeved on the outer side of the output shaft 131 and disposed between the first limiting structure 4111 and the second limiting structure 1312, that is, the biasing element 412 is disposed in the sleeve 411. The sleeve 411 can support the biasing element 412. In this example, the first limiting structure 4111 is configured to be a limiting protrusion integrally formed with the sleeve 411. In some other alternative examples, the first limiting structure 4111 may be configured to be a limiting member connected to the inner wall of the sleeve 411. In this example, the second limiting structure 1312 is configured to be a limiting member disposed on an outer wall of the output shaft 131, such as an annular gasket. In some other alternative examples, the second limiting structure 1312 may be configured to be a limiting protrusion integrally formed with the output shaft 131. In this example, the biasing element 412 is a coil spring.

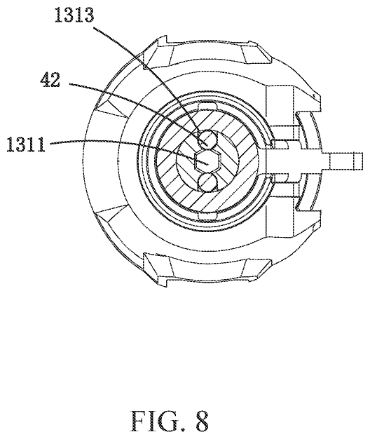

The output shaft 131 is provided with a slot 1313 communicating with the first receiving portion 1311, as shown in FIG. 8. The first locking portion 42 and the second locking portion 43 are accommodated in the slot 1313. The first locking portion 42 includes a spherical structure, a groove 511 is provided on the outer peripheral surface of the working accessory 50, and the first locking portion 42 can at least partially extend into the first receiving portion 1311. When the working accessory 50 is retained in the first receiving portion 1311, the first locking portion 42 is located in the groove 511.

The second locking portion 43 is disposed on a downstream side of the first locking portion 42 along an insertion direction F1 of the working accessory 50. The second locking portion 43 includes an elongated rocker arm structure. The second locking portion 43 is rotatably connected in the slot 1313 through a second shaft 44. When the working accessory 50 is retained in the first receiving portion 1311, the second locking portion 43 and a sidewall of the slot 1313 can limit the first locking portion 42 on two sides of the first locking portion 42, separately. In this example, the second shaft 44 is a rod-shaped shaft or a shaft pin.

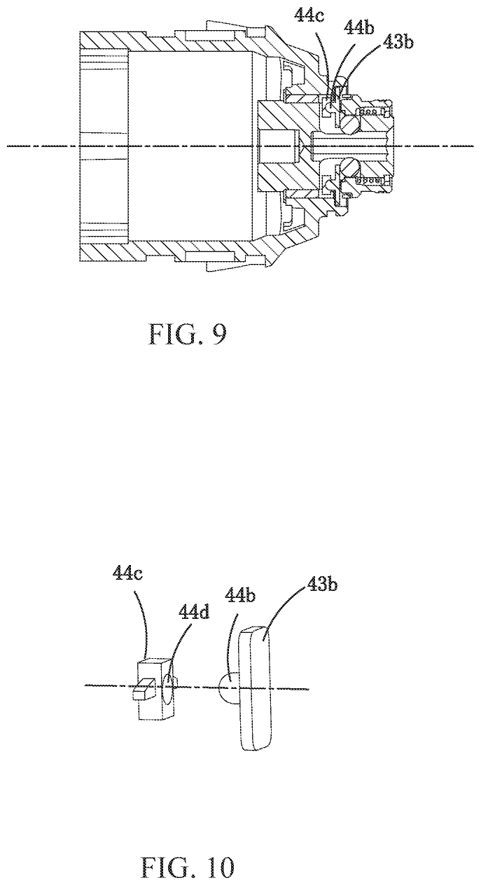

Referring to FIGS. 9 and 10, another structural form of the second locking portion and the second shaft is provided. A second locking portion 43b is an elongated rocker arm structure. The second shaft is a spherical boss 44b connected on a downstream side of the second locking portion 43b. A connecting seat 44c is provided with a groove 44d. The connecting seat 44c is mounted in the slot. The groove 44d corresponds to the spherical boss 44b so that the spherical boss 44b rotatably moves in the groove 44d. Then, the second locking portion 43b is rotatable about the spherical boss 44b. The locking mechanism 40b includes a first state (that is, an insertion process of the working accessory 50), a second state (that is, a locking process of the working accessory 50) and a third state (that is, an unlocking process of the working accessory 50).

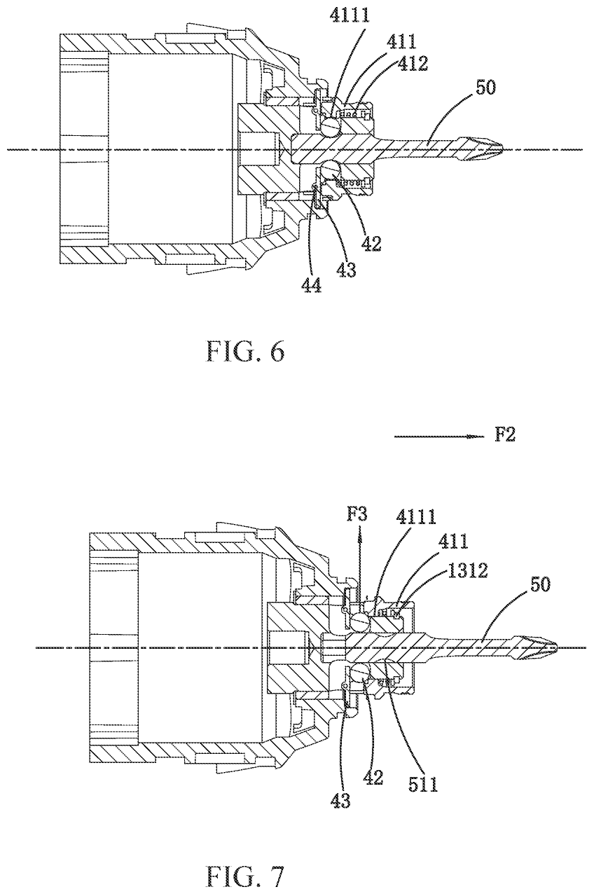

Specifically, referring to FIGS. 4 and 5, when the locking mechanism 40b is in the first state, that is, in the insertion process of the working accessory 50 into the first receiving portion 1311 along the direction F1, the working accessory 50 presses against the first locking portion 42 to apply a force to the first locking portion 42 along the insertion direction F1 of the working accessory 50. Under the action of the force, the first locking portion 42 presses against an end of the second locking portion 43. Therefore, the second locking portion 43 rotates about an axis of the second shaft 44 along a first direction (clockwise in this example) so that the other end of the second locking portion 43 applies a pressing force to the sleeve 411 to move the sleeve towards the working accessory 50. The sleeve 411 moves under the action of the force to bias against the biasing element 412. Due to a relative displacement between the sleeve 411 and the first locking portion 42, the first limiting structure 4111 releases a limitation on the first locking portion 42 so that the first locking portion 42 can move relative to the second locking portion 43. Thus, the working accessory 50 can be further inserted until the first locking portion 42 falls into the groove 511 of the working accessory 50 (as shown in FIG. 6).

Referring to FIG. 6, when the locking mechanism 40b is in the second state, that is, after the working accessory 50 is mounted in position, the force applied by the working accessory 50 to the first locking portion 42 disappears, and the pressing force applied to the sleeve 411 to move the sleeve towards the working accessory 50 also disappears. At this time, the biasing element 412 provides, through the sleeve 411, the second locking portion 43 with a biasing force for rotation about the axis of the second shaft 44 along a direction (counterclockwise in this example) opposite to the first direction, the second locking portion 43 rotate to reset under the action of the biasing force, and the sleeve 411 also moves to reset. The second locking portion 43 and the sidewall of the slot 1313 limit the first locking portion 42 on two sides of the first locking portion 42, separately, and the first limiting structure 4111 on the sleeve 411 limits the first locking portion 42 on a side of the first locking portion 42 facing away from the working accessory 50 so that the first locking portion 42 is completely limited, and the first locking portion 42 mates with the groove 511 to limit a displacement of the working accessory 50 along the direction of the first axis 101.

In some examples, a torsion spring may be additionally disposed on the second shaft 44, and the torsion spring abuts against an end of the second locking portion 43 facing the working accessory 50. When the locking mechanism 40b is in the second state, the biasing element 412 provides, through the sleeve 411, the second locking portion 43 with a biasing force BF3 for rotation about the axis of the second shaft 44 along a second direction, and the torsion spring applies a force BF4 superimposed with the force BF3 so that the second locking portion 43 rotate to reset under the action of the force BF3 and the force BF4, and the sleeve 411 also moves to reset. The torsion spring is added, which can solve the problem where the second locking portion 43 and the first locking portion 42 fail to normally reset due to the decay of an elastic force of the biasing element 412 and the problem where the first locking portion 42 easily escapes from the groove 511 during working and thus the working accessory 50 falls off.

Referring to FIG. 7, when the locking mechanism 40b is in the third state, that is, when the working accessory 50 is unlocked, a force is applied to the sleeve 411 along the extraction direction F2 of the working accessory 50, and the sleeve 411 biases against the biasing element 412 under the action of the force F5 so that the biasing force of the biasing element 412 is removed from the first locking portion 42. At this time, the first locking portion 42 can move along a direction F3 away from the working accessory 50 (referring to the direction indicated by an arrow in FIG. 7), that is, the first locking portion 42 can be disengaged from the groove 511 of the working accessory 50, thereby releasing the retention of the working accessory 50. At this time, when the working accessory 50 moves along the extraction direction F2, the first locking portion 42 moves to release a limitation on the working accessory 50 which is then extracted from the first receiving portion 1311.

In this example, an operator manually applies a force to extract the working accessory 50. In some alternative examples, an ejection structure such as a compression spring or another elastic mechanism is disposed in the first receiving portion. When the working accessory is in the second state, the compression spring or another elastic mechanism is in a compressed state. When the first locking portion releases the limitation on the working accessory 50, the compression spring or another elastic mechanism elastically resets to push the working accessory 50 out of the first receiving portion.

In the impact screwdriver 100, a central axis 501 of the working accessory 50 coincides with the first axis 101. In some other examples, the central axis of the working accessory is not parallel to the first axis.

To facilitate the application of the force to the sleeve 411 along the extraction direction of the working accessory 50, a trigger 4112 is provided on an outer wall of the sleeve 411. Referring to FIG. 2, a shift fork 4113 is provided at an end of the trigger 4112. The shift fork 4113 is connected to the sleeve 411 so that when the trigger 4112 is operated, the shift fork 4113 drives the sleeve 411 to move, thereby saving more labor.

As can be seen from the preceding operation process, the chuck device 40 provided by the present application can insert and lock the working accessory 50 with a single hand and is simple and convenient to operate.

In the related art, a chuck device that can insert the working accessory 50 with a single hand is also provided, where a spring is used as a main force receiving structure, and the spring is easy to fail, resulting in a failure of a quick clamp.

In the present application, the second locking portion 43 with the elongated rocker arm structure and the spherical first locking portion 42 form a stable clamp so that a clamping component does not easily fail. Meanwhile, the biasing element 412 is always supported by the sleeve 411, and the sleeve 411 is the main force receiving structure so that the structure is more stable, and the problem of a driving failure is not easily caused.

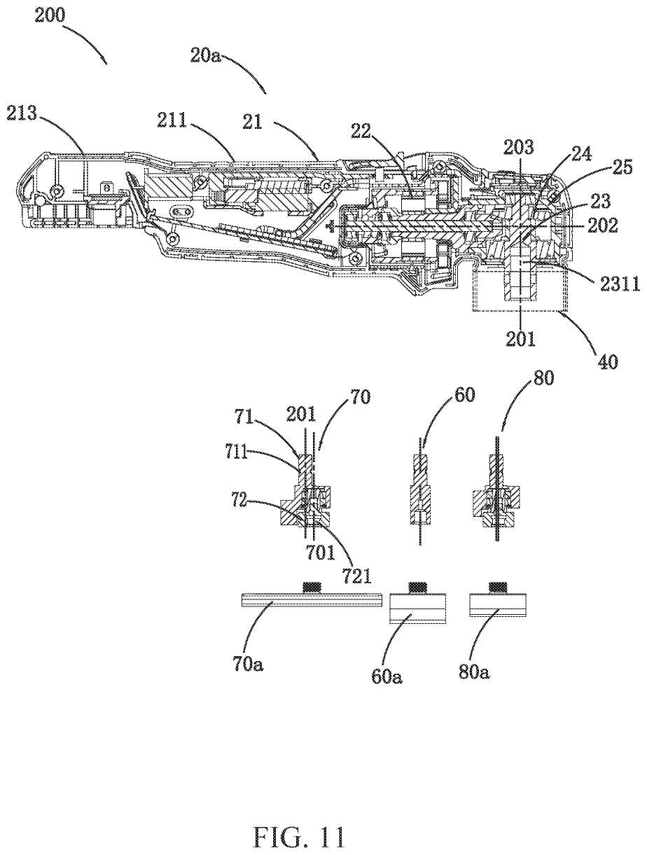

As shown in FIG. 11, in some examples, the power tool is an angular power tool, which may specifically include an angle drill, an angle grinder, a polisher and a ratchet wrench. In this example, the angular power tool is specifically a polisher 200. The polisher 200 includes a tool body 20a and a chuck device 40 connected to the tool body 20a. The working accessory is not limited to a single component, and the working accessory used in the polisher 200 is a working accessory assembly composed of multiple components. A first working accessory assembly 60 is used for implementing the function of the polisher 200 and detachably connected to the polisher 200. The first working accessory assembly 60 includes a first working accessory body 60a that moves to implement a first function such as sanding, polishing and waxing.

The tool body 20a of the polisher 200 includes a housing 21, an electric motor 22, an output shaft 23, a transmission assembly 24 and an inner housing 25. The housing 21 includes a handle portion 211 for a user to hold and a coupling portion 213 at a rear end of the handle portion 211, where the coupling portion 213 is used for mounting a power supply. In this example, the power supply is a battery pack (not shown). The housing 21 is in the shape of a straight cylinder, reducing a space occupied and facilitating use and transportation.

The electric motor 22 is disposed in the housing 21. The electric motor 22 is an outrunner or a brushless sensorless motor so that the tool body 20a is smaller in volume and weight, and the overall structure is more compact and portable. The electric motor 22 includes a motor shaft rotating about a motor axis 202.

The output shaft 23 is rotatable about an output axis 203 relative to the housing 21, and the output shaft 23 outputs power during rotation. In this example, the motor axis 202 intersects the output axis 203. It is to be understood that in this example, the motor axis 202 is orthogonal to the output axis 203. In other alternative examples, the motor axis 202 intersects the output axis 203 at other angles. The housing 21 extends along a direction of the motor axis 202.

The transmission assembly 24 is used for transmitting power between the electric motor 22 and the output shaft 23, and the inner housing 25 is disposed in the housing 21 and used for accommodating the transmission assembly 24.

A similar tool body of the polisher is illustrated and described in U.S. Pat. No. 16/862,688, the disclosure of which is incorporated herein by reference.

The polisher 200 further includes a second working accessory assembly 70 including a second working accessory body 70a. When the first working accessory assembly 60 is detached, the user may connect the second working accessory assembly 70 to the tool body 20a so that the tool body 20a outputs power to the second working accessory assembly 70, and the second working accessory assembly 70 drives the second working accessory body 70a to move to implement a second function different from the first function. It is to be understood that the first function may be one or more of sanding, polishing or waxing, and the second function may be one or more of sanding, polishing or waxing. The first function and the second function may both be sanding, polishing or waxing. For example, the first function and the second function are both sanding and differ in that the first function can implement sanding with first accuracy and the second function can implement sanding with second accuracy.

The polisher 200 further includes a third working accessory assembly 80 for connecting a third working accessory body 80a. When the first working accessory assembly 60 or the second working accessory assembly 70 is detached, the user may connect the third working accessory assembly 80 to the tool body 20a so that the tool body 20a outputs power to the third working accessory assembly 80, and the third working accessory assembly 80 drives the third working accessory body 80a to move to implement a third function.

When the user needs to perform three procedures of sanding, polishing and waxing on an automobile or a workpiece, the user can complete the three procedures by simply mounting different working accessory assemblies to the polisher 200, thereby facilitating the operation of the user, saving a cost, and improving working efficiency.

A similar first working accessory assembly 60, second working accessory assembly 70 and third working accessory assembly 80 are illustrated and described in U.S. Pat. No. 16/862,688, the disclosure of which is incorporated herein by reference.

Referring to FIG. 11, in the polisher 200, the second working accessory assembly 70 includes a second rotary member 71 and a second output member 72. The second rotary member 71 is provided with a groove 711 for being connected to the chuck device 40. The output shaft 23 is formed with a first receiving portion 2311. A first axis 201 coincides with the output axis 203. The second rotary member 71 is limited in the first receiving portion 2311 and can be driven by the output shaft 23 to rotate about the first axis 201. The second rotary member 71 is a rotary shaft. The second output member 72 includes a second driving portion 721 for connecting the second working accessory body 70a, the second driving portion 721 can drive the second working accessory body 70a to rotate, the second output member 72 is rotatably connected to the second rotary member 71, and the second output member 72 can rotate about an eccentric axis 701 relative to the second rotary member 71. The eccentric axis 701 is parallel to but does not coincide with the first axis 201, that is, the first axis 201 is parallel to but does not coincide with an axis of rotation of the working accessory body for performing an operation, where an eccentric distance is adjusted according to different use scenarios.

In some alternative examples, different position relationships between the second rotary member 71 and the second output member 72 are set so that the first axis 201 can be oblique or perpendicular relative to the axis of rotation of the working accessory body.

Regardless of the impact screwdriver 100 or the polisher 200, the output shaft 131 and the output shaft 23 are directly used as the connecting mechanism 40a. In other alternative examples, the connecting mechanism 40a may be connected to the output shaft.

It is to be understood that regardless of the impact screwdriver 100 or the polisher 200, the chuck device 40 and the tool body are used or sold as a whole. In some examples, the chuck device 40 is detachably or fixedly connected to the tool body as an independent entity. Thus, the chuck device 40 can adapt to all the preceding power tools. In some examples, the chuck device 40 may be used or sold as an independent component. Alternatively, as an after-sales spare part, the chuck device 40 is separately replaced.

The basic principles, main features, and advantages of this application are shown and described above. It is to be understood by those skilled in the art that the aforementioned examples do not limit the present application in any form, and all technical solutions obtained through equivalent substitutions or equivalent transformations fall within the scope of the present application.

What is claimed is:

1. A chuck device for clamping a working accessory, comprising:
a connecting mechanism formed with a first receiving portion to receive the working accessory and extending along a first axis; and
a locking mechanism, connected to the connecting mechanism and used for retaining the working accessory in the first receiving portion, comprising a driving portion, comprising a biasing element and a sleeve that supports the biasing element, a first locking portion at least partially extending into the first receiving portion, and a second locking portion rotatably connected to the first receiving portion through a second shaft, wherein, in a first state of the locking mechanism, the second locking portion rotates about an axis of the second shaft along a first direction to drive the sleeve to bias against the biasing element and the second locking portion drives the sleeve to release a limitation on the first locking portion.

2. The chuck device of claim 1, wherein the second locking portion comprises an elongated rocker arm.

3. The chuck device of claim 1, wherein, in a second state of the locking mechanism, the biasing element provides the second locking portion with a biasing force for rotation about the axis of the second shaft along a second direction so that the first locking portion limits a displacement of the working accessory along a direction of the first axis.

4. The chuck device of claim 3, wherein the second direction is opposite to the first direction.

5. The chuck device of claim 1, wherein, in a third state of the locking mechanism. the sleeve is driven to compress the biasing element so that a biasing force of the biasing element is removed from the first locking portion.

6. The chuck device of claim 5, wherein the first locking portion and the second locking portion move relatively to release retention of the working accessory by the first locking portion.

7. The chuck device of claim 1, wherein the biasing element transmits a biasing force to the second locking portion through the sleeve.

8. The chuck device of claim 1, wherein the first locking portion is movably connected to the second locking portion.

9. The chuck device of claim 8, wherein the first locking portion moves on the second locking portion.

10. The chuck device of claim 1, wherein a contact point between the first locking portion and the second locking portion and a contact point between the sleeve and the second locking portion are located on two sides of the second shaft.

11. The chuck device of claim 1, wherein the first locking portion comprises a spherical structure.

12. The chuck device of claim 11, wherein a groove is provided on an outer peripheral surface of the working accessory, and, when the working accessory is retained in the first receiving portion, the first locking portion is at least partially located in the groove.

13. The chuck device of claim 1, wherein the connecting mechanism is provided with a slot communicating with the first receiving portion, and the first locking portion and the second locking portion are disposed in the slot.

14. The chuck device of claim 13, wherein the second locking portion is disposed on a downstream side of the first locking portion along an insertion direction of the working accessory.

15. The chuck device of claim 13, wherein when the working accessory is retained in the first receiving portion, the second locking portion and a sidewall of the slot are capable of limiting the first locking portion on two sides of the first locking portion, separately.

16. The chuck device of claim 1, wherein the sleeve is disposed on a periphery of the connecting mechanism, an inner wall of the sleeve is provided with a first limiting structure, the connecting mechanism is provided with a second limiting structure, and the first limiting structure and the second limiting structure are spaced apart along a direction of the first axis.

17. The chuck device of claim 16, wherein the first limiting structure is disposed on an upstream side of the second limiting structure along an extraction direction of the working accessory, and the biasing element is disposed between the first limiting structure and the second limiting structure.

18. The chuck device of claim 16, wherein, when the working accessory is retained in the first receiving portion, the first limiting structure is capable of limiting a side of the first locking portion facing away from the working accessory, and, when the first limiting structure releases the limitation on the first locking portion, the working accessory is unlocked from the first receiving portion, and the first locking portion is driven to move in a direction away from the working accessory.

19. A chuck device for clamping a working accessory, comprising:
a connecting mechanism formed with a first receiving portion used for receiving the working accessory and extending along a first axis; and
a locking mechanism, connected to the connecting mechanism and used for retaining the working accessory in the first receiving portion, comprising a driving portion, comprising a biasing element and a sleeve that supports the biasing element, a first locking portion at least partially extending into the first receiving portion, and a second locking portion, comprising an elongated rocker arm and rotatably connected to the first receiving portion through a second shaft, wherein the first locking portion moves on the second locking portion and, in a first state of the locking mechanism, the second locking portion rotates about an axis of the second shaft along a first direction to drive the sleeve to release a limitation on the first locking portion.

20. A power tool, comprising:
a tool body having an output shaft and a chuck device coupled to the tool body and formed on or connected to an output shaft of the tool body, the chuck device comprising:
a connecting mechanism formed with a first receiving portion to receive the working accessory and extending along a first axis; and
a locking mechanism, connected to the connecting mechanism and used for retaining the working accessory in the first receiving portion, comprising a driving portion, comprising a biasing element and a sleeve that supports the biasing element, a first locking portion at least partially extending into the first receiving portion, and a second locking portion rotatably connected to the first receiving portion through a second shaft, wherein, in a first state of the locking mechanism, the second locking portion rotates about an axis of the second shaft along a first direction to drive the sleeve to bias against the biasing element and the second locking portion drives the sleeve to release a limitation on the first locking portion.

21. A power tool, comprising:
a tool body having an output shaft and a chuck device coupled to the tool body and formed on or connected to an output shaft of the tool body, the chuck device comprising:
a connecting mechanism formed with a first receiving portion used for receiving the working accessory and extending along a first axis; and
a locking mechanism, connected to the connecting mechanism and used for retaining the working accessory in the first receiving portion, comprising a driving portion, comprising a biasing element and a sleeve that supports the biasing element, a first locking portion at least partially extending into the first receiving portion, and a second locking portion, comprising an elongated rocker arm and rotatably connected to the first receiving portion through a second shaft, wherein the first locking portion moves on the second locking portion and, in a first state of the locking mechanism, the second locking portion rotates about an axis of the second shaft along a first direction to drive the sleeve to release a limitation on the first locking portion.
